(19) United States
(12) Patent Application Publication
(10) Pub. No.: US 2010/0064571 A1
(43) Pub. Date: Mar. 18, 2010

(54) COMBO REEL SEAT WITH FASTENER MEMBER

(75) Inventor: CLARK PATRICK McCUNE, JENKS, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: W.C. BRADLEY/ZEBCO HOLDINGS, INC, Tulsa, OK (US)

(21) Appl. No.: 12/211,451

(22) Filed: Sep. 16, 2008

(51) Int. Cl. A01K 87/06

(52) U.S. Cl. 43/22; 242/316

(57) ABSTRACT

A rod and reel, wherein the reel has a body portion and a foot portion, is described herein. The foot portion defines an orifice. A reel seat has a first end and a second end. The reel seat defines a receptacle for receiving the foot portion of the reel on a top side of the reel seat. The reel seat defines at least one orifice on a lower side. A rod has a base end that is received within the first end of the reel seat. A handle portion is affixed to the second end of the reel seat. A zip tie surrounds the real seat and passes secures the foot portion of the reel to the real seat, e.g., the zip tie may pass through the orifice on the foot portion and through the orifice on the lower side of the reel seat.

### FIELD OF THE INVENTION

This invention relates generally to a fishing reel. More particularly, but not by way of limitation, the present invention relates to a fishing reel wherein an attachment device is provided to secure a reel to a rod.

### BACKGROUND OF THE INVENTION

Fishing reels for sport fishing are known in the art and are available in a variety of styles such as bait casting reels, spin casting reels, spinning reels, fly fishing reels, etc. Such reels are available with a wide variety of features that enhance the fishing experience.

Fishing rod and reel combinations are oftentimes offered for sale in large retail stores. To assist a purchaser in determining whether to purchase a particular rod and reel combination, the packaging may allow for the purchaser to manipulate components of the rod and reel. A potential downside of allowing access to the merchandise is that the rod and reel could be disassembled and a component removed for theft or for other reasons.

Consequently, rod and reel combos are typically packed with a length of fastener material such as a “zip tie” wrapped around a foot portion of a reel and also around a reel seat affixed to the rod. The term “zip tie” refers to a type of fastener that may also be referred to as a cable tie or tie wrap. The length of the fastener member makes removal of the reel from the rod problematic, and, therefore, discourages in store removal.

Although the fastener member is designed to be removed, purchasers may elect to maintain the fastener member on the rod and reel to reduce a chance of accidental disengagement of the components or for other reasons. As commonly installed, the length of the fastener member is untidy and presents a potentially uncomfortable gripping surface on the rod and reel handle.

Therefore, a rod and reel combination having an improved fastener member connection is desirable.

### SUMMARY OF THE INVENTION

The rod and reel packaging of the invention minimizes the amount of fastener member material required to secure the rod to the reel, improves user grip comfort by moving the fastener member away from the grip area, increases the speed of combo assembly, and adds an additional location for a hang tag attachment. A hole is provided in the reel seat to allow a fastener member to pass therethrough. The reel seat fastener member hole can be used on both a casting reel seat and a spinning reel seat. In a preferred embodiment, the fastener member can also be threaded through a hole in the foot of the reel. Alternatively, the fastener member may be wrapped over both ends of the reel foot and secured to the rod by threading the fastener member through the reel seat hole to secure the rod and reel. The rod and reel packaging of the invention enables a user to fish comfortably without removing the fastener member, and therefore avoids the reel separating from the rod if the reel seat should become loose during use.

The rod and reel packaging of the invention can be used on both new and existing reels and may be modified for larger and smaller sized rod and reel combos. An additional hole in the reel seat may be provided to give a fastener member location for attaching tackle boxes, fishing accessories, hang tags, or attaching the combo to packaging.

### BRIEF DESCRIPTION OF THE DRAWINGS

FIG. 1 is a plan view of a rod and reel combo.

FIG. 2 is an enlarged view of a reel foot/reel seat interface in the rod and reel of FIG. 1.

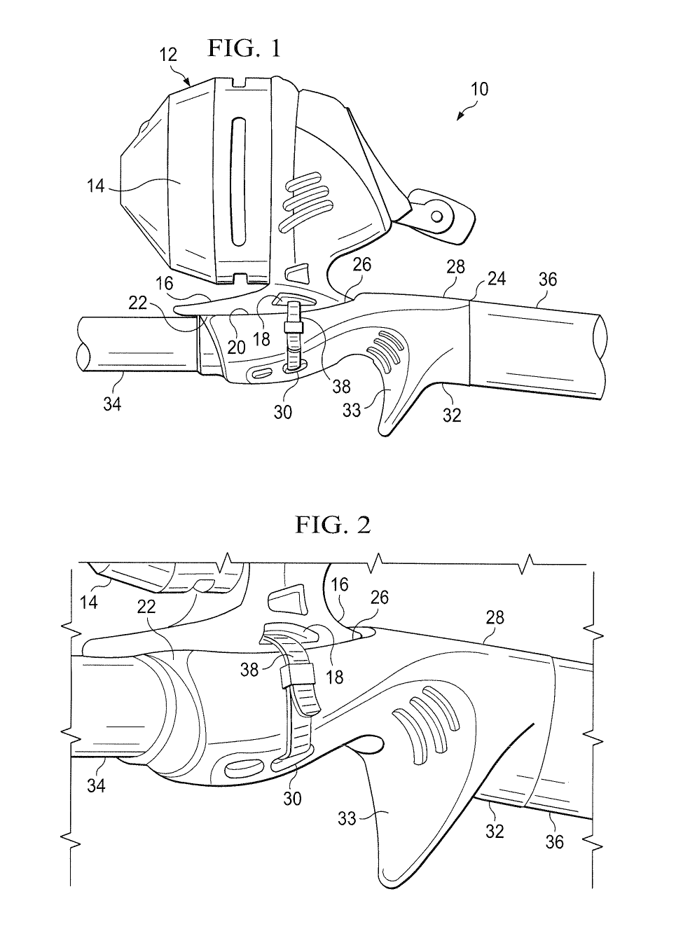

### DETAILED DESCRIPTION OF THE PREFERRED EMBODIMENTS

Rod and reel combination 10 includes a reel 12 having a body portion 14 and a foot portion 16. Foot portion 16 defines a first orifice 18. Foot portion 16 of reel 12 may also define additional orifices as desired.

A reel seat 20 is provided having a first end 22 and a second end 24. Reel seat 20 defines a receptacle 26 for receiving foot portion 16 on an upper side 28 and defining at least one orifice 30 on lower side 32. Lower side 32 of reel seat 20 additionally defines a gripping surface 33. Rod 34 has a base end for being received within first end 22 of reel seat 20. A handle portion 36 is affixed to second end 24 of reel seat 20. An attachment member 38, such as a zip tie, surrounds reel seat 20 and passes through first orifice 18 on foot portion 16 of reel 12. Attachment member 38 additionally passes through orifice 30 on lower side 32 of reel seat 20.

The placement of the attachment member 38 as described above removes attachment member 38 from an outer surface of gripping surface 33, therefore, eliminating a potential source of annoyance for the user, in the event that the user desires to leave attachment member 38 in place.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A rod and reel comprising:
a reel having a body portion and a foot portion;
a reel seat defining a receptacle for receiving said foot portion on a top side and defining at least one orifice on a lower side;
a fastener member surrounding said reel seat and passing over a portion of said foot portion and through said orifice on said lower side.

2. The rod and reel according to claim 1 wherein:
said foot portion defines an orifice for receiving said fastener member.

3. The rod and reel according to claim 1 wherein:
said lower side of said reel seat defines a gripping structure.

4. The rod and reel according to claim 3 wherein:
said fastener member does not contain an outer surface of said gripping structure.
